(19) United States
(12) Patent Application Publication
(10) Pub. No.: US 2012/0318513 A1
(43) Pub. Date: Dec. 20, 2012

(54) CORRODIBLE DOWNHOLE ARTICLE AND METHOD OF REMOVING THE ARTICLE FROM DOWNHOLE ENVIRONMENT

(75) Inventors: Oleg A. Mazyar, Houston, TX (US); Matthew T. McCoy, Richmond, TX (US)

(73) Assignee: BAKER HUGHES INCORPORATED, Houston, TX (US)

(21) Appl. No.: 13/162,781

(22) Filed: Jun. 17, 2011

(51) Int. Cl. E21B 37/06; B05D 1/18; C25D 3/00; E21B 33/12

(52) U.S. Cl. 166/304; 166/193; 427/436; 205/261

(57) ABSTRACT

A method of removing a corrodible downhole article having a surface coating includes eroding the surface coating by physical abrasion, chemical etching, or a combination of physical abrasion and chemical etching, the surface coating comprising a metallic layer of a metal resistant to corrosion by a corrosive material.

### BACKGROUND

Certain downhole operations involve placement of elements in a downhole environment, where the element performs its function, and is then removed. For example, elements such as ball/ball seat assemblies and fracture (frac) plugs are downhole elements used to seal off lower zones in a borehole in order to carry out a hydraulic fracturing process (also referred to in the art as “fracking”) to break up reservoir rock. After the fracking operation, the ball/ball seat or plugs are then removed to allow fluid flow to or from the fractured rock.

To facilitate removal, such elements may be formed of a material that reacts with the ambient downhole environment so that they need not be physically removed by, for example, a mechanical operation, but may instead corrode or dissolve under downhole conditions. However, because operations such as fracking may not be undertaken for months after the borehole is drilled, such elements may have to be immersed in downhole fluids for extended periods of time (for example, up to a year, or longer) before the fracking operation begins. Therefore, it is desirable to have corrodible downhole elements such as ball seats and frac plugs that are protected from uncontrolled corrosion during that period of time, and which then can be subsequently made corrodible as needed.

### SUMMARY

The above and other deficiencies of the prior art are overcome by a method of removing a corrodible downhole article having a surface coating, comprising eroding the surface coating by physical abrasion, chemical etching, or a combination of physical abrasion and chemical etching, the surface coating comprising a metallic layer of a metal resistant to corrosion by a corrosive material.

In another embodiment, a method of removing a corrodible downhole article which comprises a magnesium alloy core, and a metallic layer covering the magnesium alloy core, the metallic layer being resistant to corrosion by a corrosive material, the method comprising eroding the metallic layer by physical abrasion, chemical etching, or a combination of physical abrasion and chemical etching, and corroding the corrodible downhole article in a corrosive material after eroding.

In another embodiment, an article for forming a downhole seal comprises a magnesium alloy core, and a metallic layer having a thickness of about 100 to about 500 micrometers and covering the magnesium alloy core, the metallic layer being formed of nickel, aluminum, or an alloy thereof, and resistant to corrosion by a corrosive material, the article being a ball seat or frac plug.

In another embodiment, a method of making an article for forming a downhole seal, comprising plating, in the absence of water, a metallic layer having a thickness of about 100 to about 500 micrometers and resistant to corrosion by a corrosive material, on a surface of a magnesium alloy core, the article being a ball seat or frac plug.

### BRIEF DESCRIPTION OF THE DRAWINGS

Referring now to the drawings wherein like elements are numbered alike in the several Figures:

FIG. 1 shows a cross-sectional view of a corrodible downhole article 100 prior to removal of a protective coating 111 and seating of a ball 130; and

FIGS. 2A-2C show cross-sectional views of the sequential process for removing a protective coating 211 from a corrodible downhole article 200 (FIG. 2A), seating a ball 230 (FIG. 2B) in a seating zone 210 before fracking, and removing the ball 230 and seating zone 210 after fracking (FIG. 2C).

### DETAILED DESCRIPTION OF THE INVENTION

A corrodible downhole article is disclosed, such as a ball seat or frac plug, where the downhole article includes a corrodible core, which dissolves in a corrosive environment, and a metallic layer covering the core. The metallic layer has sufficient thickness to resist scratching and premature erosion, but which is thin enough to be eroded physically, chemically, or by a combination including at least one of these types of processes prior to seating a ball on the ball seat. In this way, the seated core can be exposed to the corrosive downhole environment and the corrodible core corroded away to remove the article.

The corrodible downhole article, which is useful for forming a seal, includes a corrodible core that corrodes under downhole conditions, and a surface coating, which includes a metallic layer. The corrodible core has the surface coating on a surface of the core material.

The corrodible core comprises any material suitable for use in a downhole environment provided the core material is corrodible in the downhole environment. Core materials can include corrodible metals, metal oxides, composites, soluble glasses, and the like. Useful such core materials dissolve under aqueous conditions.

In an embodiment, the core material is a magnesium alloy. The magnesium alloy core includes magnesium or any magnesium alloy which is dissolvable in a corrosive environment including those typically encountered downhole, such as an aqueous environment which includes salt (i.e., brine), or an acidic or corrosive agent such as hydrogen sulfide, hydrochloric acid, or other such corrosive agents. Magnesium alloys suitable for use include alloys of magnesium with aluminum (Al), cadmium (Cd), calcium (Ca), cobalt (Co), copper (Cu), iron (Fe), manganese (Mn), nickel (Ni), silicon (Si), silver (Ag), strontium (Sr), thorium (Th), tungsten (W), zinc (Zn), zirconium (Zr), or a combination comprising at least one of these elements. Particularly useful alloys include magnesium alloy particles including those prepared from magnesium alloyed with Ni, W, Co, Cu, Fe, or other metals. Alloying or trace elements can be included in varying amounts to adjust the corrosion rate of the magnesium. For example, four of these elements (cadmium, calcium, silver, and zinc) have to mild-to-moderate accelerating effects on corrosion rates, whereas four others (copper, cobalt, iron, and nickel) have a still greater effect on corrosion. Exemplary commercial magnesium alloys which include different combinations of the above alloying elements to achieve different degrees of corrosion resistance include but are not limited to, for example, those alloyed with aluminum, strontium, and manganese such as AJ62, AJ50x, AJ51x, and AJ52x alloys, and those alloyed with aluminum, zinc, and manganese such as AZ91A-E alloys.

It will be appreciated that alloys having corrosion rates greater than those of the above exemplary alloys are contemplated as being useful herein. For example, nickel has been found to be useful in decreasing the corrosion resistance (i.e., increasing the corrosion rate) of magnesium alloys when included in small amounts (i.e., less than 1% by weight). In an embodiment, the nickel content of a magnesium alloy is less than or equal to about 0.5 wt %, specifically less than or equal to about 0.4 wt %, and more specifically less than or equal to about 0.3 wt %, to provide a useful corrosion rate for the corrodible downhole article. In an exemplary embodiment, the magnesium particles are alloyed with about 0.25 wt % Ni.

The above magnesium alloys are useful for forming the core, and are formed into the desired shape and size by casting, forging and machining. Alternatively, powders of magnesium or the magnesium alloy are useful for forming the core. The magnesium alloy powder generally has a particle size of from about 50 to about 150 micrometers (μm), and more specifically about 60 to about 140 μm. The powder is further coated using a method such as chemical vapor deposition, anodization or the like, or admixed by physical method such cryo-milling, ball milling, or the like, with a metal or metal oxide such as Al, Ni, W, Co, Cu, Fe, oxides of one of these metals, or the like. Such coated magnesium powders are referred to herein as controlled electrolytic materials (CEM). The CEM materials are then molded or compressed into the desired shape by, for example, cold compression using an isostatic press at about 40 to about 80 ksi (about 275 to about 550 MPa), followed by forging or sintering and machining, to provide a core having the desired shape and dimensions.

It will be understood that the magnesium alloys, including CEM materials, will thus have any corrosion rate necessary to achieve the desired performance of the article. In a specific embodiment, the magnesium alloy or CEM material used to form the core has a corrosion rate of about 0.1 to about 20 mg/cm²/hour, specifically about 1 to about 15 mg/cm²/hour determined in aqueous 3 wt % KCl solution at 200° F. (93° C.).

The corrodible downhole article further has a surface coating, which includes a metallic layer. The metallic layer is resistant to corrosion by a corrosive material. As used herein, “resistant” means the metallic layer is not etched or dissolved by any corrosive downhole conditions encountered (i.e., brine, hydrogen sulfide, etc., at pressures greater than atmospheric pressure, and at temperatures in excess of 50° C.) such that any portion of the magnesium alloy core is exposed, for a period of greater than or equal to one year, specifically for a period of greater than or equal to two years.

The metallic layer includes any metal resistant to corrosion under ambient downhole conditions, and which can be removed by eroding as explained below. In an embodiment, the metallic layer includes nickel, aluminum, alloys thereof, or a combination comprising at least one of the foregoing. In an embodiment, the metallic layer is aluminum or aluminum alloy. In an embodiment, the metallic layer includes a single layer, or includes multiple layers of the same or different metals. In this way, the surface coating includes, in an embodiment, a metallic layer disposed on the core, and one or more additional layers of metal and/or metal oxide on the metallic layer. In an embodiment, adjacent, contacting layers in the surface coating have different compositions (e.g., are of different metals, combinations of metal and metal oxide, etc.). Such outer layers may be formed by coating the metal layer with another metal, forming an oxide or anodized layer, or any such method of forming the outer layers.

The metallic layer has a thickness of less than or equal to about 1,000 micrometers (i.e., about 1 millimeter). In an embodiment, the metallic layer may have a thickness of about 10 to about 1,000 micrometers, specifically about 50 to about 750 micrometers and still more specifically about 100 to about 500 micrometers. The metallic layer covers a portion of the surface of the magnesium alloy core, or covers the entirety of the magnesium alloy core.

The metallic layer is applied to the corrodible core by any suitable method, provided that the application process is not carried out in the presence of agents which can react with the magnesium core, and which cause damage to the surface of the magnesium metal core, such that the desired properties of the metallic layer or magnesium alloy core are substantially adversely affected.

The metallic layer is thus formed by any suitable method for depositing a metal, including an electroless plating process, or by electrodeposition. Any suitable known method for applying the metallic layer can be used, provided the method does not significantly adversely affect the performance of the core after plating, such as by non-uniform plating or formation of surface defects affecting the integrity of the plated metallic layer on the magnesium alloy core.

Electroless deposition is useful for applying a uniform layer of metal over complex surface geometries. For example, the metal coating can be a nickel coating applied by an electroless process to the magnesium core such as that described by Ambat et al. (Rajan Ambat, W. Zhou, Surf. And Coat. Technol. 2004, vol. 179, pp. 124-134) or by Liu et al. (Zhenmin Liu, Wei Gao, Surf. And Coat. Technol. 2006, vol. 200, pp. 5087-93), the contents of both of which are incorporated herein by reference in their entirety.

In another embodiment, plating is be carried out by electrodeposition in the presence of an anhydrous ionic solvent (i.e., in the absence of moisture). It will be appreciated that the presence of adventitious water during the plating process may cause surface pitting, or may cause formation of metal hydroxides, such as magnesium hydroxide, on the surface of the magnesium alloy core. Such surface defects may lead to a non-uniform adhesion of the metallic layer to the core, or may undesirably cause surface defects which can lead to weakened or compromised integrity of the metallic layer, hence reducing the effectiveness of the metallic layer in protecting the magnesium alloy core against corrosion.

A useful method of making an article thus includes plating the metallic layer in the absence of water, to form a metallic layer having a thickness of about 100 to about 500 micrometers and resistant to corrosion by a corrosive material, on a surface of a magnesium alloy core. For example, electrodeposition to apply an aluminum coating on a surface of a magnesium alloy can be carried out using, as a plating medium, aluminum chloride in 1-ethyl-3-methylimidazolium chloride as an ionic liquid, according to the literature method of Chang et al. (Jeng-Kuei Chang, Su-Yau Chen, Wen-Ta Tsai, Ming-Jay Deng, I-Wen Sun, Electrochem. Comm. 2007, vol. 9, pp. 1602-6), the contents of which are incorporated herein by reference in their entirety. In an embodiment, the article is a ball seat or frac plug.

Articles useful for downhole applications include ball seats and frac plugs. In an embodiment, the article has a generally cylindrical shape that tapers in a truncated, conical cross-sectional shape such as a ball seat, with an inside diameter in cylindrical cross-section of about 2 to about 15 cm, sufficient to allow, for example, a ball to fit downhole and to seat and form a seal in the desired downhole element. In a further embodiment, the surface is milled to have a concave region having a radius designed to accommodate a ball or plug.

In an embodiment, a method of removing the corrodible downhole article from a downhole environment includes eroding the surface coating of the article by physical abrasion, chemical etching, or a combination of physical abrasion and chemical etching, the surface coating being a metallic layer of a metal resistant to corrosion by a corrosive material. In another embodiment, the eroding is accomplished by physical abrasion alone.

Eroding comprises flowing a slurry of a proppant over the surface of the corrodible downhole article. A proppant includes any material useful for injecting into the fractured zones after the fracking process, to prop open the fractures in the downhole rock. Proppants useful herein have a hardness and abrasiveness greater than that of the surface layer. For example, useful proppants include sand including rounded sand grains, aluminum pellets, glass beads, ceramic beads including those based on alumina and zirconia, and the like, and combinations comprising at least one of the foregoing. In some embodiments, the proppant is polymer coated or is coated with a curable resin. Typical proppants have a mesh size of about 12 to about 70 mesh. The proppant is slurried in any suitable fluid used for fracking or other downhole fluid. For example, the fracking fluid includes distillate, diesel fuel, kerosene, polymer-based fluids, and aqueous fluids such as water, brine, dilute hydrochloric acid, or aqueous viscoelastic fluids such as those described in U.S. Pat. No. 7,723,272 which contains water, a viscoelastic surfactant (VES), additives to reduce viscosity (after delivery of the proppant), viscosity stabilizers and enhancers, and fluid loss control agents. A mixture of these fracking fluids with other solvents and/or surfactants commonly used in downhole applications is also useful herein.

Eroding includes partially or completely removing the metallic layer. Partial removal of the metallic layer during erosion, such as by wearing away patches, strips, or scratches which remove a portion of the surface of the metallic layer and which expose the underlying magnesium alloy, is in some embodiments sufficient to allow penetration of a corrosive material to and dissolution of the magnesium alloy. It will be appreciated that though physical abrasion by proppant is disclosed, the method is not limited to this. Abrasion may also be accomplished by other mechanical means, such as for example by insertion of a downhole tool or element and moving the tool or element with or against the corrodible downhole article to scratch or abrade the metallic layer.

The method further includes corroding the corrodible downhole article in a corrosive material after eroding. The corrosive material includes, for example, water, brine, an acid including hydrochloric acid, hydrogen sulfide, or a combination comprising at least one of the foregoing. In an embodiment, the corrosive material is injected downhole as a slurry containing the proppant, such as for example, a slurry of the proppant in brine, or is injected in a separate operation.

In another embodiment, a method of forming a reversible seal with a corrodible downhole article includes seating a ball or plug in the corrodible downhole article having a shaped surface, such as a concave shape, which accommodates a surface shape such as complementary a convex shape of the ball or plug, the corrosive downhole article comprising a magnesium alloy core, and a metallic layer covering the magnesium alloy core. The metallic layer is resistant to corrosion by a corrosive material as described above. The downhole article prevents fluid flow further downhole when a ball or plug is seated in the downhole article.

Seating is accomplished by placing a ball or plug in the downhole environment, and applying pressure to the downhole environment to effect seating. Placing means, in the case of a ball seat, dropping a ball into the well pipe, and forcing the ball to settle to the ball seat by applying pressure. As discussed above, the balls come in a variety of sizes scaled to seat with specific sized ball seats for isolating different fracture zones. For example, a lower fracture zone has a ball seat accommodating a smaller diameter ball than the ball seat for an upper fracture zone, so that the ball for sealing the lower fracture zone passes through the ball seat for the upper fracture zone, while the ball sized for the upper fracture zone seats on the upper fracture zone ball seat.

Forming the reversible seal further comprises removing the metallic layer of the corrodible downhole article, prior to seating, by injecting a slurry of a proppant into the downhole environment at a pressure greater than that of the downhole environment. During removing, the proppant slurry flows past the article and erodes the metallic layer to expose the magnesium alloy core to the downhole environment. In this way, the ball or plug seats in the corrodible downhole article (e.g., ball seat) directly on the exposed magnesium alloy core.

Unseating of the corrodible downhole article can be accomplished by reducing the pressure applied to the downhole environment. This allows the pressure in the area below the seat to push up the seated ball, when the pressure applied to the downhole environment becomes less than that of the ambient downhole pressure.

In an embodiment, a method of removing a corrodible downhole article includes eroding the metallic layer by physical abrasion, chemical etching, or a combination of physical abrasion and chemical etching as described above, and corroding the corrodible downhole article in a corrosive material after eroding.

Removing the corrodible downhole article is accomplished by corroding the downhole article, after removal of at least a portion of the protective metallic layer, in a corrosive material present downhole. A useful corrosive material includes one of those described herein, and is included with the proppant, or is injected downhole after the proppant. For example, a slurry of a proppant in brine both erodes the metallic layer and corrodes the magnesium alloy core. The abrasive action of the proppant erodes the metallic layer to expose all or a portion of the magnesium alloy core, and the exposed magnesium alloy core then corrodes in the brine of the proppant slurry.

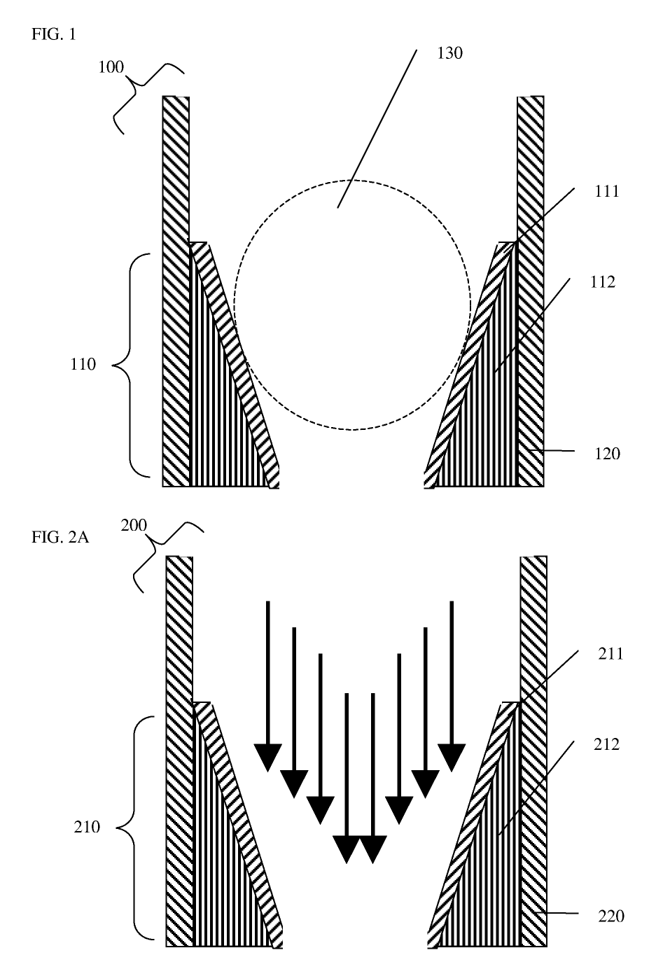

The ball seat 100 is shown in schematic cross-section in FIG. 1. In FIG. 1, a ball seat 100 includes a surface coating layer 111 and magnesium alloy core 112 located in a seating zone 110 for accommodating a ball 130 (with the approximate location of the seated ball 130 shown by dashed lines). The narrowed seating zone 110 is within a housing 120, which is attached to a pipe or tube (not shown). The enclosure 120 has a composition different from that of the magnesium alloy core 112. The ball seat 100, with ball 130 seated in seating zone 110 (after removal of the surface coating layer 111), closes off the lower (narrower) end of the ball seat 100 so that fracking is selectively carried out in the region above the seating zone 110.

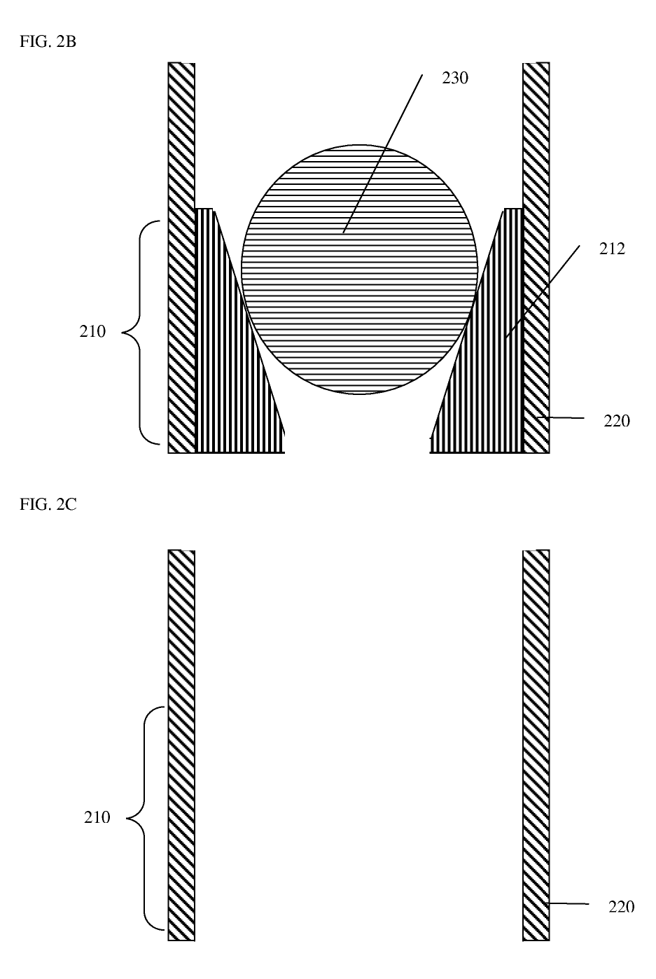

In FIG. 2, the process of using the ball seat 200 is shown. In FIG. 2A, the ball seat 200 is shown prior to seating and fracking. A slurry of an abrasive material such as a proppant or other abrasive material is passed into the fracking zone below the ball seat 200 (arrows showing direction of flow) through the seating zone 210, which erodes away all or a portion of the surface coating layer 211 to expose the magnesium alloy core 212. FIG. 2B shows the exposed magnesium alloy core 212, with a ball 230 seated in the seating zone 210 after the surface coating layer 211 has been removed by the action of the proppant. After fracking, the seated ball 230 and the magnesium alloy core 212 are exposed to a corrosive material, such as brine, which dissolves away the magnesium alloy core 212 (and hence seating zone 210). The ball 230 can be removed by dissolving while seated, or can first be unseated. FIG. 2C shows the ball seat 200 after removal (by dissolution) of the seating zone 210, where only housing 220 remains.

While one or more embodiments have been shown and described, modifications and substitutions may be made thereto without departing from the spirit and scope of the invention. Accordingly, it is to be understood that the present invention has been described by way of illustrations and not limitation.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of removing a corrodible downhole article having a surface coating, the method comprising:
eroding the surface coating by physical abrasion, chemical etching, or a combination of physical abrasion and chemical etching,
the surface coating comprising:
a metallic layer of a metal resistant to corrosion by a corrosive material.

2. The method of claim 1, the corrodible downhole article further comprising a corrodible core having the surface coating on a surface of the corrodible core.

3. The method of claim 2, wherein the corrodible core comprises magnesium alloy having less than or equal to about 0.5 weight percent of nickel.

4. The method of claim 1, wherein eroding is by physical abrasion alone.

5. The method of claim 1, wherein eroding comprises flowing a slurry of a proppant over the surface of the corrodible downhole article.

6. The method of claim 5, wherein the proppant includes sand, aluminum pellets, glass beads, ceramic beads, and combinations comprising at least one of the foregoing.

7. The method of claim 1, further comprising corroding the downhole article in the corrosive material after eroding.

8. The method of claim 7, wherein the corrosive material is water, brine, an acid, hydrogen sulfide, or a combination comprising at least one of the foregoing.

9. The method of claim 1, wherein the metallic layer has a thickness of less than or equal to about 1,000 micrometers.

10. The method of claim 1, wherein the metallic layer is formed by an electroless plating process, or by an electrodeposition process in the presence of an anhydrous ionic solvent.

11. The method of claim 10, wherein the metallic layer comprises nickel, aluminum, alloys thereof, or a combination comprising at least one of the foregoing.

12. The method of claim 1, wherein the corrodible downhole article is a ball seat or frac plug.

13. A method of forming a reversible seal with a corrodible downhole article, comprising
seating a ball or plug in the corrodible downhole article having a shaped surface which accommodates a surface shape of the ball or plug, the corrodible downhole article comprising:
a magnesium alloy core, and
a metallic layer covering the magnesium alloy core, the metallic layer being resistant to corrosion by a corrosive material,
wherein the corrodible downhole article prevents fluid flow when seated.

14. The method of claim 13, wherein seating comprises placing the article a downhole environment and applying pressure to the downhole environment.

15. The method of claim 14, further comprising removing the metallic layer of the corrodible downhole article, prior to seating, by injecting a slurry of a proppant into the downhole environment at a pressure greater than that of the downhole environment.

16. The method of claim 15, wherein the proppant slurry flows past the article and erodes the metallic layer to expose the magnesium alloy core.

17. The method of claim 14, further comprising unseating the corrodible downhole article by reducing the pressure applied to the downhole environment to a pressure below that of an ambient downhole pressure.

18. The method of claim 17, further comprising corroding the exposed magnesium alloy core in a corrosive material.

19. A method of removing a corrodible downhole article, the article comprising:
a magnesium alloy core, and
a metallic layer covering the magnesium alloy core, the metallic layer being resistant to corrosion by a corrosive material,
the method comprising eroding the metallic layer by physical abrasion, chemical etching, or a combination of physical abrasion and chemical etching, and
corroding the corrodible downhole article in the corrosive material after eroding.

20. An article for forming a downhole seal, comprising:
a magnesium alloy core, and
a metallic layer having a thickness of about 100 to about 500 micrometers and covering the magnesium alloy core, the metallic layer being formed of nickel, aluminum, or an alloy thereof, and resistant to corrosion by a corrosive material,
the article being a ball seat or frac plug.

21. A method of making an article for forming a downhole seal, comprising
plating, in the absence of water,
a metallic layer having a thickness of about 100 to about 500 micrometers and resistant to corrosion by a corrosive material, on
a surface of a magnesium alloy core,
the article being a ball seat or frac plug.
